(19) United States
(12) Patent Application Publication
(10) Pub. No.: US 2004/0010936 A1
(43) Pub. Date: Jan. 22, 2004

(54) Dryer

(76) Inventor: In Hee Han, Kyongsangnam-do (KR)

Correspondence Address: Song K Jung, McKenna Long & Aldridge, 1900 K Street N W, Washington, DC, 20006, US

(21) Appl. No.: 10/415,495

(22) PCT Filed: Sep. 4, 2002
(86) PCT No.: PCT/KR02/01677

(30) Foreign Application Priority Data
Sep. 5, 2001 (KR) 200154546

(51) Int. Cl. F26B 11/02

(52) U.S. Cl. 34/595

(57) ABSTRACT

The present invention discloses a dryer for easy discharge of heated air form an inside thereof. For this, the dryer of the present invention includes a drum (32) for receiving laundry and rotating in any one direction, heating means (33) for producing heated air to be supplied to the drum for drying the laundry, an air discharge assembly for discharging air from the drum (32) to outside of the dryer, and a cabinet (30) being configured to contain the drum (32), the heating means (33), and the air discharge assembly therein, the cabinet including an opening (50) for discharging air circulated around the heating means (33) or the air discharge assembly by rotation of the drum (32), thereby discharging air that is heated secondarily by the heating means (33) and the air discharge assembly.

### TECHNICAL FIELD

The present invention relates to a dryer, and more particularly, to an air circulating structure for use in a dryer capable of discharging air outwardly from an inside of a cabinet.

### BACKGROUND ART

FIG. 1 is an exploded perspective view of main parts of a conventional dryer, and FIG. 2 is a cross sectional view of main parts of the conventional dryer.

As shown in FIGS. 1 and 2, a drum 1 is installed in an inside a cabinet 28 forming its appearance. The drum 1 has a cylindrical shape with both ends thereof opened, and is rotated by a separate driving unit. To this end, the drum 1 is provided at an outer periphery thereof with a belt groove 2, which a driving belt (not shown) is wound on the belt groove. The drum 1 includes a drying chamber 5 for receiving the laundry to be dried therein. Also, the drum 1 is provided at an inner periphery thereof with a baffle 1a for tumbling the laundry within the drying chamber 5 during the rotation of the drum 1.

The drum 1 is provided at both opened ends thereof with a front head 7 and a rear head 9, respectively. The front head 7 and the rear head 9 supports front and read ends thereof, respectively. A sealant 10 is interposed between the front head 7 and the drum 1 and between the rear head 9 and the drum 1 for prevent the leakage. The front head 7 is formed with a throughhole 8 for communicating the interior and exterior of the drying chamber 5, and the throughhole 8 is selectively open/closed by a door (not shown).

The drum 1 is provided with a discharge assembly extended from the front head 7 to the outside of the dryer. The discharge assembly serves as a role of discharging the heated air, which is used for drying the laundry, to the outside of the dryer, and includes an outlet assembly 13, a lint filter 14, a lint duct 15, a blower 17, and a discharge pipe 19. Specifically, the outlet assembly 13 consisting of several components is installed at a lower end of the through-hole 8 of the front head 7 so as to discharge the air from the drying chamber 5. The outlet assembly 13 is provided at a front thereof with the lint filter 14 for filtering out small, fine particles such as pieces of thread or dust from the air discharged from the drying chamber 5. Also, the lint duct 15 is communicated with the outlet assembly 13, and the lint filter 14 is located in the inside of the lint duct 15 and the outlet assembly 13. The blower 17 is communicated with the lint duct 15, and sucks the air from the interior of the drying chamber 5 through the lint duct 15. The blower 17 is installed in a blower housing 18. One end of the blower housing 18 is communicated with the lint duct 15, and the other end thereof is coupled to the exhaust pipe 19 toward the exterior. Therefore, the air flowing from the drying chamber 5 through the lint duct 15 is outwardly discharged through the exhaust pipe 16 by the blower 17.

An air supply duct 12 is installed at a rear of the rear head 9, and serves as a passage of supplying the heated air to the inside of the drying chamber. A heated-air duct 20 is communicated with the air supply duct 12. The heated-air duct 20 is to guide the heated air required in the interior of the drying chamber 5. To this end, the heated-air duct 20 is provided at an inlet thereof with a gas nozzle 22 constructing a gas burner 21. The gas nozzle 22 serves as a role of injecting the supplied gas. The gas nozzle 22 has a valve for controlling the supply of the gas. A reference numeral 23 indicates a gas pipe. The burner 21 includes a mixing pipe 22 extending from the inlet of the heated-air duct 20 to the interior thereof for mixing the gas injected from the gas nozzle 22 with a primarily air. In the mixing pipe 24, the gas injected by the gas nozzle 22 is mixed with the external air, i.e., the primarily air, flowing in through the inlet of the mixing pipe 24. The mixing pipe 24 is provided at a front end thereof with a spark plug 26 for igniting the burner.

The structure of the conventional dryer has a following problem.

As shown in FIG. 2, the interior of the cabinet 28 is not a fully sealed space, but the air circulation between the interior thereof and the exterior doest not smoothly result in. Besides the air primarily heated by the burner 21 and transferred to the drying chamber 5, the air existed in the interior of the cabinet 28 is secondarily heated by various heat sources. Specifically, the air within the cabinet 28 is secondarily heated by the heat generated by the gas burner 21, the heat generated by motors driving the drum 1 or the blower, and the heat generated from the discharge assembly discharging the heated air. The air within the cabinet 28 is increased to a relatively high temperature during the operation of the dryer, and in particular, flows into one place within the cabinet 28 by the rotation of the drum 1. For example, if the drum 1 is rotated in a direction indicated by an arrow A in FIG. 2, the air flows in the cabinet 28 according to the rotational direction of the drum 1.

Specifically, since there are several heat sources such as burner 21 and discharge assembly, as described above, relatively lots of heat is generated at the lower portion of the drum 1. The air in the lower portion of the drum 1 flows into any region H within the cabinet 28 by the rotation of the drum 1. In particular, since the region is located in a narrow gap between the drum 1 and the cabinet 28, the air does not flow.

During the operation of the dryer, a portion of the cabinet 28 adjacent to the region H is continuously heated in the end. The portion of the cabinet is damaged due to the heat, and a user may get burnt his/her body on the heated cabinet.

### DISCLOSURE OF THE INVENTION

Accordingly, the present invention is directed to a dryer that substantially obviates one or more of the problems due to limitations and disadvantages of the related art.

An object of the present invention is to provide a dryer capable of easily discharging the heated air therein.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, there is provided a dryer comprising: a drum receiving laundry and being rotatable in a constant direction; heating means for producing heated air, which is supplied to an interior of the drum, for drying the laundry; a discharge assembly for discharging the heated air from the drum to an exterior of the dryer; and a cabinet adapted to accommodate the drum, the heating means and the discharge assembly, and having an outlet for discharging air flow produced around the heating means or the discharge assembly by a rotation of the drum, so that the air secondarily heated by the heating means and the discharge assembly is discharged through the outlet.

Preferably, the outlet is formed at a portion of the cabinet which is in contact with the air flow. The heating means and the discharge assembly are positioned at a lower portion of the cabinet, and the outlet is formed at a lower side wall of the cabinet.

More preferably, the outlet is formed at a portion of a side wall of the cabinet which meets a rotational tangent line of the drum at a lowermost of the drum. Alternatively, the outlet is formed at a right or left side wall of the cabinet along a rotational direction of the drum.

Preferably the outlet further has air guide means.

The dryer of the present invention further comprises an inlet formed at a bottom surface of the cabinet for sucking exterior air to an interior of the cabinet. The inlet further has air guide means.

With the descriptions of the dryer according to the present invention, the air flow heated within the cabinet is easily discharged, so that it prevents the damage of the components or the injury of the user due to the heat.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exploded perspective view of main parts of a conventional dryer;

FIG. 2 is a cross sectional view of main parts of a conventional dryer;

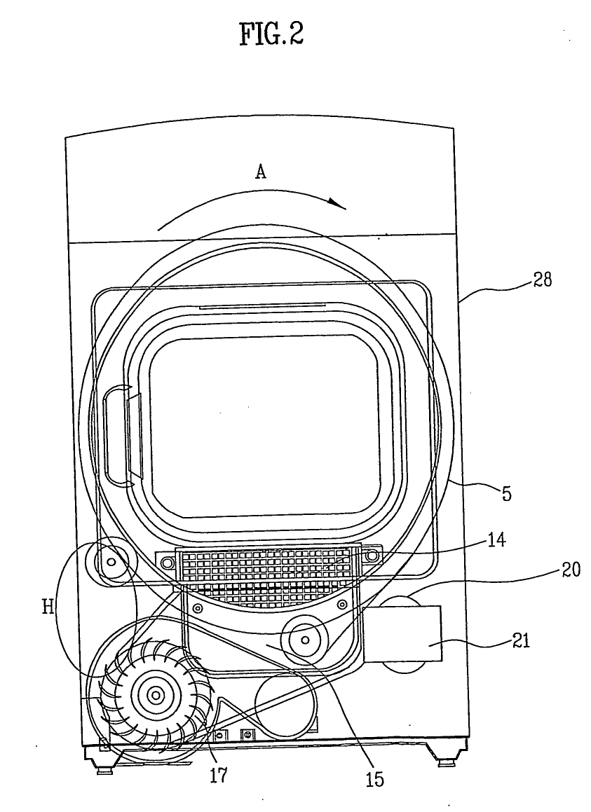

FIG. 3 is a cross sectional view of a dryer according to the present invention; and

FIG. 4 is a cross sectional view for showing the air circulation within a dryer of the present invention.

### BEST MODE FOR CARRYING OUT THE INVENTION

Reference will now be made in detail to a preferred embodiment of the present invention, an example of which is illustrated in the accompanying drawings. In the embodiment, like parts are shown by corresponding reference numerals throughout the drawings, and additive explanation thereof will be omitted.

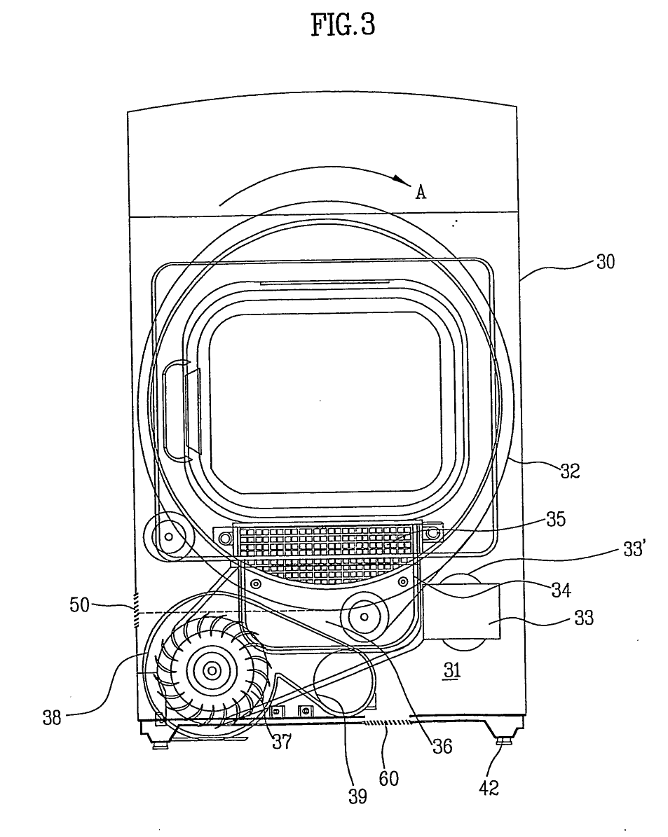

FIG. 3 is a cross sectional view of the interior structure of a dryer according to the present invention. As shown in FIG. 3, a cabinet 30 forms the appearance of the dryer. The dryer may include a front panel, a top panel, a real panel and so forth depending upon the specification of an article.

The dryer is formed therein with a space by the cabinet 30. Several components forming the dryer are installed in the space 31. A drum 32 including a drying chamber is rotatably installed in the space. The drum 32 is rotated by a separate driving unit (not shown). Heating means 33 is positioned at a lower portion of the space 31, i.e., at a location corresponding to a lower portion of the drum 32. The heating means 33 includes an electric heater or gas burner. The heat generated by the heating means 33 forms heated air to be supplied into the interior of the drum 32 within the heated-air duct 33′. The heated air is guided by the heated-air duct 33′, and is transferred to the drum 32 through a desired duct (not shown, similar to the air supply duct 12 shown in FIG. 12).

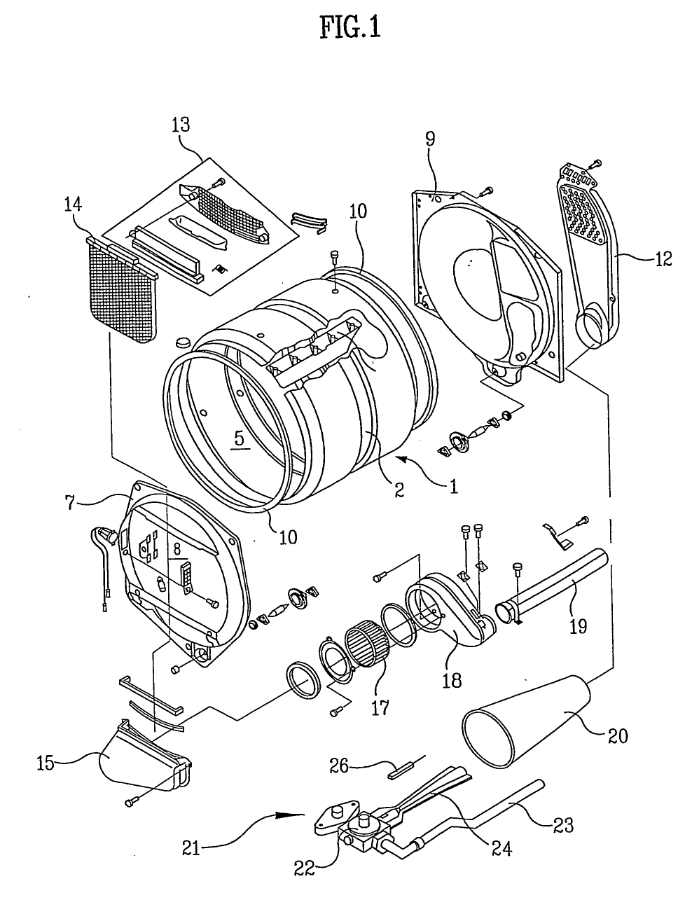

The drum 1 is provided with a discharge assembly for discharging the heated air within the drying chamber to the outside of the dryer, the structure of which is substantially similar to that of the conventional discharge assembly shown in FIG. 1. In such the discharge assembly, the drum 32 is provided with at a front thereof with the outlet assembly 34 for discharging the heated air from the drum 32, which is used in a drying process within the drum 32. The outlet assembly 34 is provided with a lint filter 35 for filtering out small, fine particles such as pieces of thread from the air discharged from the drying chamber. Also, a discharge duct 35 is formed at the discharge assembly 34. A blow housing 38 is connected to the discharge duct 36, and a blower 37 is installed in the blower housing 38, so that the air is discharged from the drum 32 through the discharge duct 36. The air flow formed by the blower 37 is discharged outwardly through the discharge duct 39 connected to the blower housing 38.

Various components of the dryer (for example, heating means and discharge assembly) are generally installed on the bottom surface of the cabinet 30, except for the drum 1, so that they are stably supported. In addition, legs 42 are located at four corners of the bottom surface to more stably support the dryer.

Meanwhile, besides the heated air for drying the laundry, the air within the cabinet 30 is secondarily heated by various components serving as a heat source. In particular, the secondary heat is greatly influenced by the heating means such as burner and the discharge assembly. In other words, such heated air flows by the rotation of the drum 32, and locally heats the cabinet 30, so that each component may be partially damaged by the heat. Accordingly, the cabinet 30 is formed with an outlet 50 to discharge the air flow heated by the heat source with the rotation of the drum 32.

Preferably, the outlet 50 is formed at a portion of the cabinet which is in contact with the air flow. Specifically, as described above, in case the major heat source such as the heating means 33 and the discharge assembly is positioned on the lower portion of the cabinet 30, the outlet is formed at a lower side wall of the cabinet 30.

More specifically, since the air flow circulating in the same direction as the rotational direction of the drum 32 along the surroundings thereof is deviated in a tangential direction at the surroundings, the outlet 50 is preferably formed on an extension of a traveling direction of the air flow. Preferably, the outlet 50 is formed at a portion of the side wall of the cabinet which meets a tangent line (indicated by a dotted line) of the drum at the lowermost of the drum 32. On the other hand, as described above, since the air flow direction is determined by the rotational direction of the drum 32, the outlet 50 has to be formed at a different position depending upon the rotational direction of the drum 32. Accordingly, the outlet 50 is formed at a right or left side wall of the cabinet 30 depending upon the rotational direction of the drum 32. Specifically, in the embodiment, as shown in FIG. 3, if the drum 32 is rotated in a direction indicated by an arrow A (clockwise), the outlet 50 is formed at a lower end of the left side wall of the cabinet 30. If the rotational direction of the drum 32 is in a counter direction, the outlet 50 is formed at the right side wall of the cabinet.

In order to easily discharge the air outwardly, the outlet may include desired means of guiding the air. The air guide means may be a duct or a louver of a desired length formed at the outlet 50.

In order to more facilitate the air flow in the space 31, the cabinet may be at the bottom surface thereof with an inlet 60. The air of a relatively lower temperature may be supplied to the interior of the cabinet 30 through the inlet 60 from the exterior of the dryer. In addition, in order to more facilitate the air inflow within the cabinet 30, like the outlet 50, the inlet 60 may include air guide means such as a duct or a louver.

The operation of the dryer according to the present invention will now be described.

If the dryer operates, the drum 32 is rotated, and heated air produced by the heat supplied from the heat source 33 is transferred to the interior of the drum 32 through the heated-air duct 33′. In the drum 32, the laundry is rotated and dried. The heated air used for drying the laundry in the drum 32 is sucked by the blower 37, and is discharged to the exterior of the dryer through the discharge duct 39.

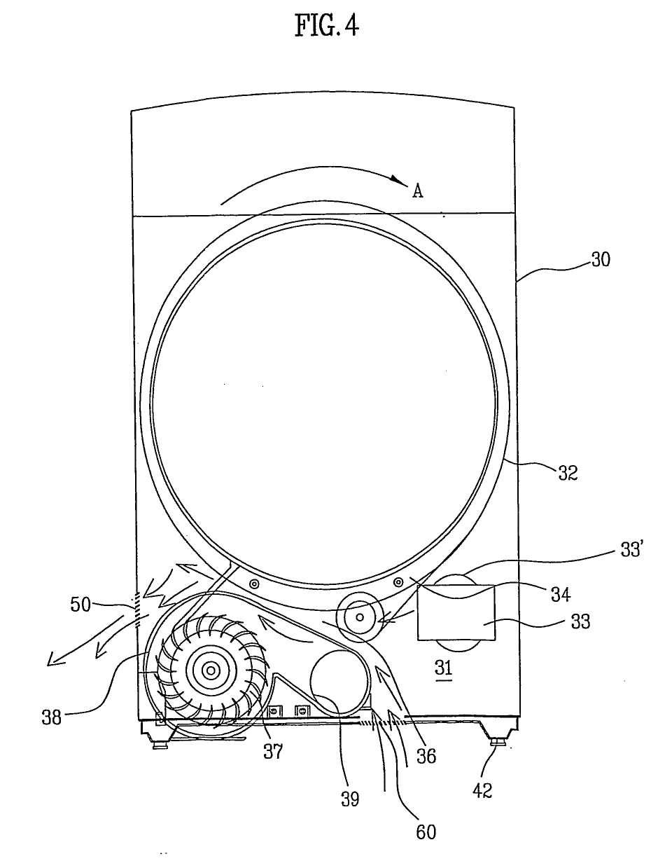

Simultaneously, the air is circulated in the interior space 31 of the cabinet 30 by the rotation of the drum 32, as shown in FIG. 4. Referring to FIG. 4, if the drum is rotated in a clockwise direction (indicated by an arrow A), the air is circulated in the same direction as the rotational direction of the drum 32. In particular, the air heated at the surroundings of various heat sources (for example, heating means 33, the discharge assembly and the like) flows by the rotation of the drum 32. Such air flow is deviated from the drum 32, and then further progresses toward the side wall of the cabinet 32, i.e., the outlet 50. The heated air in the space 31 is easily discharged to the exterior of the dryer through the outlet 50.

In case of forming the inlet 60, the exterior air is induced by the air flow produced in the space 31 to flow in through the inlet 60. The inflow air is also circulated toward the outlet 50 by the rotation of the drum 32. Accordingly, since the air flow is more actively caused in the space 31, it facilitates the discharge of the air flow through the outlet 50, and the heated air is more easily discharged. In addition, since the exterior air is cooler than the air within the dryer, the sucked exterior air is to reduce the interior temperature of the space 31 and cool the heat produced from the drum 32. Accordingly, the air discharged through the outlet 50 which is of a temperature lower than that of the air sucked through the inlet 60 is discharged to the exterior of the dryer.

While the present invention has been described and illustrated herein with reference to the preferred embodiment thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

With the descriptions of the dryer according to the present invention, the heated air within the cabinet may be outwardly discharged by the air circulation produced due to the rotation of the drum through the properly designed outlet. Accordingly, it minimizes the possibility in that components constructing the dryer may be damaged due to the heat.

The outlet for discharging the air from the cabinet is designed in view of the rotational direction of the drum, and the inlet for sucking the exterior air of relatively lower temperature in the cabinet is formed at the bottom surface of the cabinet. Therefore, there is an effect in that since the temperature of the air discharged through the outlet is relatively lowered, it prevents the injury of the user due to the heat.

What is claimed is:

1. A dryer comprising:
a drum receiving laundry and being rotatable in a constant direction;
heating means for producing heated air, which is supplied to an interior of the drum, for drying the laundry;
a discharge assembly for discharging the heated air from the drum to an exterior of the dryer; and
a cabinet adapted to accommodate the drum, the heating means and the discharge assembly, and having an outlet for discharging air flow produced around the heating means or the discharge assembly by a rotation of the drum, so that the air secondarily heated by the heating means and the discharge assembly is discharged through the outlet.

2. The dryer as claimed in claim 1, wherein the outlet is formed at a portion of the cabinet which is in contact with the air flow.

3. The dryer as claimed in claim 2, wherein the heating means and the discharge assembly are positioned at a lower portion of the cabinet, and the outlet is formed at a lower side wall of the cabinet.

4. The dryer as claimed in claim 1, wherein the outlet is formed at a portion of a side wall of the cabinet which meets a rotational tangent line of the drum at a lowermost of the drum.

5. The dryer as claimed in claim 4, wherein the outlet is formed at a right or left side wall of the cabinet along a rotational direction of the drum.

6. The dryer as claimed in claim 1, wherein the outlet further has air guide means.

7. The dryer as claimed in claim 1, further comprising an inlet formed at a bottom surface of the cabinet for sucking exterior air to an interior of the cabinet.

8. The dryer as claimed in claim 7, wherein the inlet further has air guide means.

9. An air circulating structure for a dryer, the air circulating structure comprising:
a drum receiving laundry and being rotatable in a constant direction; and
an outlet formed at a cabinet of the dryer for discharging air flow produced around various heat sources by a rotation of the drum, so that the air secondarily heated by the heat sources is discharged through the outlet.

10. The air circulating structure as claimed in claim 9, wherein the outlet is formed at a portion of the cabinet which is in contact with the air flow.

11. The air circulating structure as claimed in claim 10, wherein the heat sources are positioned at a lower portion of the cabinet, and the outlet is formed at a lower side wall of the cabinet.

12. The air circulating structure as claimed in claim 11, wherein the outlet is formed at a portion of a side wall of the cabinet which meets a rotational tangent line of the drum at a lowermost of the drum.

13. The air circulating structure as claimed in claim 12, wherein the outlet is formed at a right or left side wall of the cabinet along a rotational direction of the drum.

14. The air circulating structure as claimed in claim 9, wherein the outlet farther has air guide means.

15. The air circulating structure as claimed in claim 9, further comprising an inlet formed at a bottom surface of the cabinet for sucking exterior air to an interior of the cabinet.

16. The air circulating structure as claimed in claim 15, wherein the inlet further has air guide means.
